(19) United States
(12) Patent Application Publication
(10) Pub. No.: US 2011/0099897 A1
(43) Pub. Date: May 5, 2011

(54) Method of Vegetative Propagation of Jatropha Curcas L

(76) Inventors: Robert Tjandra, Toronto (CA); Teuku Tajuddin, Tangerang (ID); Minaldi Minaldi, Tangerang (ID)

(21) Appl. No.: 12/612,392

(22) Filed: Nov. 4, 2009

(51) Int. Cl. A01G 1/00

(52) U.S. Cl. 47/58.1 FV

(57) ABSTRACT

The present invention is a method of vegetative propagation of Jatropha Curcas L. which includes the steps of treating viable plants with a shoot stimulator to initiate shoots, sterilizing the harvested shoots, treating the harvested shoots with a root stimulator and then planting the treated shoots. The shoot stimulator is preferably a synthetic plant hormone solution such as a solution of 2,4-Dichlorophenoxyacetic acid. The apical shoots are then harvested and sterilized in a cleansing solution before treating with the root stimulator. The root stimulator consists of an auxin in combination with Benzylaminopurine, thiamine, chelated iron, and mono sodium glutamate. The treated shoots are then planted to produce new plants.

### FIELD OF THE INVENTION

The invention relates generally to methods of vegetative propagation.

### BACKGROUND OF THE INVENTION

Jatropha Curcas L is tropical plant which has significant economic potential. The seeds of the plant are very high in oil, which when squeezed from the seeds, can be used directly as a bio diesel fuel source. The plant, being highly prolific and fast growing in tropical climates, is therefore a potential source of bio diesel fuel and, potentially, a lucrative cash crop. However, propagating Jatropha Curcas L is problematic. Propagation of this plant is generally accomplished by way of seed propagation. However, the genetic variations which arise in a crop of Jatropha Curcas L as a result of seed propagation often results in lower yields. Ideally, genetically identical crops of Jatropha Curcas L are preferred because they are more likely to result in higher yields. However, the reproductive cycle of Jatropha Curcas L does not lend itself to genetically identical seeds. Unfortunately, vegetative techniques for propagating the plant have generally been of limited success. Therefore, finding an efficient method of vegetative propagation of the plant is a key step in the commercial exploitation of this potential bio diesel fuel source.

### SUMMARY OF THE INVENTION

In accordance with one aspect of the present invention, there is provided a method of vegetative propagation of Jatropha Curcas L. which is simple, cost effective and high yielding. The method includes the steps of treating viable Jatropha Curcas L plants with a shoot stimulator to initiate shoots. The shoot stimulator is preferably a synthetic plant hormone solution such as a solution of 2,4-Dichlorophenoxyacetic acid. The new shoots are then harvested and then sterilized. The sterilized shoots are then treated with a root stimulator, namely an auxin in combination with Benzylaminopurine, thiamine, and chelated iron. The treated shoots are then planted to produce new plants.

The present invention is further directed at a method of vegetative propagation of Jatropha Curcas L. which includes the steps of treating viable Jatropha Curcas L plants with a shoot stimulator to stimulate the development of shoots, harvesting the shoots propagated and then treating the harvested shoots with a root stimulator. The shoot stimulator is selected from the group of plant hormones including 2,4-Dichlorophenoxyacetic acid, α-Napthalene acetic acid, 2-Methoxy-3,6-dichlorobenzoic acid, 4-Amino-3,5,6-trichloropicolinic acid and α-(p-Chlorophenoxy) isobutyl acid. The root stimulator includes a solution of an auxin and a cytokinin. The treated shoots can then be planted.

The present invention is further directed at a method of vegetative propagation of Jatropha Curcas L. which includes the steps of first treating viable Jatropha Curcas L plants with a synthetic auxin to stimulate the development of shoots, harvesting the shoots and then treating the harvested shoots with a root stimulator. The root stimulator includes a mixture of a auxin and a cytokinin.

The present invention is further directed at a method of vegetative propagation as described in the proceeding paragraphs wherein the root stimulator further includes thiamine and chelated iron.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DETAILED DESCRIPTION OF THE INVENTION

Propagating Jatropha Curcas L is not easy. Simple cuttings from the plant will not grow reliably as it does with many other plants. In order to reliably produce Jatropha Curcas L in large quantities, it has been discovered that a particular regiment of hormone and chemical treatments is required. Most basically, the method of propagating Jatropha Curcas L in large quantities includes the basic steps of treating viable plants with a shoot stimulator to stimulate the development of new shoots, treating the shoots with a root stimulator and then planting the treated shoots. The first step, treating viable Jatropha Curcas L with a shoot stimulator will first be described.

The shoot stimulator consists of a solution of a plant hormone, preferably a synthetic auxin. It will be appreciated that there are several synthetic auxins which are available, such as α-Napthalene acetic acid, 2-Methoxy-3,6-dichlorobenzoic acid, 4-Amino-3,5,6-trichloropicolinic acid and α-(p-Chlorophenoxy) isobutyl acid. However, the synthetic auxin which is preferred for use in this method is 2,4-Dichlorophenoxyacetic acid (2,4-D). 2,4-D has been discovered to be very effective in stimulating the production of axial shoots in Jatropha Curcas L. The shoot stimulator is preferably prepared at a concentration of 1,000 mg/liter. Preferably, the shoot stimulator should also include an aqueous fertilizer solution. The ingredients of the preferred fertilizer solution which is to be used to create the shoot stimulator are listed in table 1 below, the balance consisting of water. The shoot stimulator preferably includes the fertilizer at a concentration of about 950 ml/liter, with the remaining solution consisting of water.

TABLE 1
Composition of the Aqueous Fertilizer Solution

| Fertilizer Solution | 1,000.00 | ml |
|---|---|---|
| Nitrogen | 12.35 | % |
| Phosphate | 7.30 | % |
| Potassium (K) | 9.20 | % |
| Calcium | 1.80 | % |
| Magnesium | 0.90 | % |
| Sulphate | 1.30 | % |
| Fe-EDTA | 0.07 | % |
| Manganese | 0.10 | % |
| Zinc | 0.05 | % |
| Boron | 0.11 | % |
| Copper | 0.01 | % |
| Moliybdenite | 0.01 | % |

The following is a brief discussion as to how the preferred fertilizer solution for use with the present invention is created.

### Vegetative Fertilizer Formula Preparation

Step One—Making Potassium Nitrate solution stock.
1. Prepare a clean 200 liter tank
2. Fill the tank with 150 liter water.
3. Weigh 50 kg potassium nitrate.
4. Put the Potassium Nitrate into the tank and mix with hand mixer till all dissolve.
5. Add more water to obtain volume of solution to 200 liter.
6. Leave the solution for a minimum of 24 hour.
Step Two—Making Calcium Nitrate solution stock.
1. Prepare a clean 200 liter tank
2. Fill the tank with 150 liter water.
3. Weigh 50 kg calcium nitrate
4. Put the Potassium Nitrate into the tank and mix with hand mixer till all dissolve.
5. Add more water to obtain volume of solution to 200 liter.
6. Leave the solution for a minimum of 24 hour.
Step 3—fertilizer formula preparation
1. Prepare a clean 200 liter tank
2. Fill the tank with 90 liter water
3. Weigh the raw materials as follows: Potassium dihydrogen phosphate 12 kg, mono-ammonium phosphate 5 kg, ammonium sulphate 20 kg, magnesium sulphate 10 kg, manganese sulphate 40 g, zinc sulphate 40 g, boric acid 60 g, cuprum sulphate 20 g, ammonium Molybdate 10 g, and Fe-EDTA 50 g.
4. Put each of the above raw materials one by one into the tank while mixing with hand mixer.
5. After all the ingredients have been dissolved completely, leave the solution for a minimum of 24 hours.
6. Add 4 liter of Potassium Nitrate solution stock and 2 liter of Calcium Nitrate solution stock.
7. Mix the solution until it becomes homogen and take pH measurement, if the solution pH is above 7, add Nitric Acid 4 N solution drop by drop and mixing the solution until the solution pH becomes 6.8-7, add clean water to the solution till the volume reaches 100 liter.
8. Some of the fertilizer solution is used for making the shoot stimulator formula and the rest of the fertilizer solution is packed into 500 ml plastic packaging (packaging is opaque to light).

The following is a brief discussion as to how the actual preferred shoot stimulator solution is created.

Shoot Stimulator Formula
Making 5 liter of 2,4-Diclorophenoxy acetic acid 100,000 ppm solution stock.
1. Prepare 5 liter glass beaker.
2. Fill with 2,000 ml water.
3. Weigh 500 gram of 2,4-D
4. Put into the glass beaker.
5. Stir with magnetic stirrer and slowly add potassium hydroxide 4 N solution
6. After the 2,4-D dissolved completely, add distilled water till solution volume reaches 4,900 ml.
7. Check the solution pH, and add slowly Hydrochloric acid 4 N till the solution pH is 6.8. Add distilled water till the solution volume reaches 5 liter.
8. Keep the 2,4-D solution in Refrigerator.
Shoot Stimulator Formula Preparation
1. Prepare 200 liter tank.
2. Put 49.5 liter of the fertilizer solution into the tank.
3. Add 500 ml water and mix with hand mixer till well blended.
4. Add 500 ml of 2,4D solution stock, then mix thoroughly
5. Check solution pH to be 6.8-7
6. The shoot stimulator formula is then packed into, 500 ml plastic packaging (packaging is opaque to light).

Treating the viable plants with the shoot stimulator involves nothing more than applying a few ml of the shoot stimulator to the soil or growth media surround the roots of the plant. The treated plants then start to produce large quantities of apical shoots, which propagate from the main stem of the plant. These apical shoots can then be harvested by cutting them from the main plant stem.

After the apical shoots are harvested, they should be sterilized. It has been discovered that sterilizing the cut shoots significantly increases the percentage of shoots which will grow into viable new plants after planting. Preferably the sterilization procedure involves soaking the cut shoots in a cleansing agent bath. The cleansing agent preferably consists of a mixture of 60% carbendazim (at 20 grams per liter) and streptomycin sulphate (also at 20 grams per liter).

The following details how the preferred cleansing (sterilizing) solution concentrate is created. This concentrated is then mixed with about 1 liter of water to form the sterilizing (cleansing) bath solution.

Sterilizing—Cleansing Formula.
Cleanse Concentrate formula preparation
1. Prepare a 100 gram plastic packaging.
2. Weigh 15 gram of Carbendazym 60% and 20 gram of Streptomycin Sulphate 20%.
3. Mix with hand mixer the two ingredients above till well blended, then put into the 100 gram plastic packaging.
4. Put the packaging into a labeled 35 gram pack.

After soaking in the cleansing bath for a few minutes, the shoots are removed from the bath and left to air dry at room temperature. One end of each shoot is then treated with a root stimulator.

The root stimulator consists of a paste like mixture of plant hormones, including auxins and cytokinins in combination with other ingredients such as thiamine and iron. The particular ingredients making up the root stimulator are listed in table 2 below.

TABLE 2
List of Ingredients for the Root Stimulator

| | | |
|---|---|---|
| Naphthalene Acetic Acid | 500.00 | mgr/liter |
| Indole Butyric Acid | 250.00 | mgr/liter |
| Benzyl Amino Purine | 2.50 | mgr/liter |
| Mono Sodium Glutamate | 25.00 | mgr/liter |
| Thiamine HCl | 0.50 | mgr/liter |
| Fe-EDTA | 2.00 | mgr/liter |

The following is a brief description as to how the preferred root stimulator is made.

Root Stimulator Formula.
Making Indole Butyric Acid (IBA) solution stock.
1. Prepare 10 liter glass beaker.
2. Fill with 500 ml water.
3. Weight 50 gram of IBA.
4. Put the IBA into the glass beaker, and mix on the magnetic stirrer.
5. Add slowly KOH 4 N solution into the beaker till all the IBA is dissolved.
6. Measure the solution pH, and if it is above 7 add 4 or more drops of Nitric Acid 4 N solution till pH of 6.8.
7. Add water till the solution volume reaches 5 liter.
8. Store the IBA solution stock in refrigerator.
Making Naphthalene Acetic Acid (NAA) solution stock.
1. Prepare 10 liter glass beaker, and fill it with 500 ml water.
2. Weigh 50 gram of NAA, and put into the glass beaker.
3. Put the beaker on the magnetic stirrer, and stir it up.
4. Add KOH 4 N drop by drop until all the NAA material has been dissolved.
5. Measure the solution pH, and if the pH is above 7, then add Nitric Acid 4 N solution drop by drop till the pH reaches 6.8-7.
6. Add water to the NAA solution until the volume reaches 5 liter.
7. Store the NAA solution stock in refrigerator.
Making Benzyl Amino Purine (BAP) solution stock.
1. Prepare 1 liter glass beaker.
2. Fill the beaker with 500 ml of water.
3. Weight 5 gram of Benzyl Amino Purine (BAP).
4. Put the BAP material into the beaker.
5. Stir using magnetic stirrer while adding HCl 4 N solution drop by drop till all the BAP material is dissolved.
6. Measure the solution pH if the pH is below 6.8 then add NaOH 4 N solution drop by drop until the BAP solution pH reaches 6.8-7.
7. The BAP solution is then poured into 1 liter measuring container, and then adds water until the BAP solution reaches 1 liter volume.
8. Pour the BAP solution stock into 1 liter dark bottle and store in refrigerator.
Making Thiamine HCl solution stock.
1. Prepare 500 ml glass beaker.
2. Pour 200 ml water into the beaker.
3. Weigh 10 gram of Thiamine HCL, and put into the beaker.
4. Stir with magnetic stirrer until all the Thiamine HCl material is dissolved.
5. Pour the solution into a 1 liter measuring container, and add water until the solution volume reaches 1 liter.
6. Pour the Thiamine HCl solution stock into a 1 liter bottle, and store in refrigerator.
Making Amino Acid (MSG) solution stock.
1. Prepare 500 ml glass beaker.
2. Pour 300 ml water into the beaker.
3. Weigh 10 gram of Amino Acid (mono-sodium-glutamate), and put into the beaker.
4. Stir with magnetic stirrer until all the material is dissolved.
5. Pour the solution into a 1 liter measuring container, and add water until the solution volume reaches 1 liter.
6. Pour the solution into a 1 liter glass bottle, and store in refrigerator.
Making Fe-EDTA solution stock.
1. Prepare 500 ml glass beaker, and pour 300 ml water into it.
2. Measure 10 gram of Fe-EDTA, and put it into the beaker.
3. Stir using magnetic stirrer until all the material is dissolved.
4. Pour the solution into a 1 L measuring container, and add water until the volume reaches 1 L
5. Pour the solution into a 1 liter bottle, and store in refrigerator.

As can be seen in table 2, the principle ingredients of the root stimulator include the plant hormones Naphthalene Acetic Acid and Indole Butyric Acid (both of which are auxins) and Benzyl Amino Purine (a synthetic cytokinin). Mono Sodium Glutamate (MSG) is added to increase the viability of the cutting, as is thiamine (in the form of thiamine HCl) and iron (in the form of chelated iron, Fe-EDTA). It has been discovered that adding thiamine, in the form of thiamine HCl, to the root stimulator greatly increases the effectiveness of the root stimulator. Likewise, the addition of Fe-EDTA and MSG also significantly enhances the effectiveness of the root stimulator. This particular combination of ingredients is particularly effective in increasing the ability of the shoots to propagate roots when planted in a planting medium.

The root stimulator is applied to the cut end of the shoot. Preferably, the root stimulator is made in the form of a thick paste which can be applied to the shoot by simply dipping the cut end of the shoot into the paste.

After the shoots have been treated with the root stimulator, the shoots can be incubated in a growth medium until roots begin to form. The incubation period is generally about two weeks, with roots being formed within seven to ten days. The incubated shoots can then be transferred to individual poly bags (or similar structures) and then planted in the field. The plants will grow quite rapidly in a warm climate, particularly when fertilized with the fertilizer solution described in table 1 above.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A method of vegetative propagation of Jatropha Curcas L. comprising the steps of:
a) treating viable Jatropha Curcas L plants with a shoot stimulator to initiate shoots, said shoot stimulator comprising 2,4-Dichlorophenoxyacetic acid;
b) harvesting the shoots;
c) sterilizing the harvested shoots;
d) treating a base end of the sterilized shoots with a root stimulator, said root stimulator comprising an auxin in combination with Benzylaminopurine, thiamine and chelated iron, and
e) planting the treated shoots.

2. A method of vegetative propagation of Jatropha Curcas L. comprising the steps of:
a) Treating viable Jatropha Curcas L plants with a shoot stimulator to stimulate the development of shoots, said shoot stimulator selected from the group comprising 2,4-Dichlorophenoxyacetic acid, α-Napthalene acetic acid, 2-Methoxy-3,6-dichlorobenzoic acid, 4-Amino-3,5,6-trichloropicolinic acid and α-(p-Chlorophenoxy) isobutyl acid;
b) Harvesting the shoots;
c) Treating the harvested shoots with a root stimulator comprising an auxin and a cytokinin, and
d) Planting the treated shoots.

3. A method of vegetative propagation of Jatropha Curcas L. comprising the steps of:
a) Treating viable Jatropha Curcas L plants with a shoot stimulator to stimulate the development of shoots, the shoot stimulator comprising a synthetic auxin;
b) Harvesting the shoots;
c) Treating the shoots with a root stimulator comprising an auxin and a cytokinin, and;
d) Planting the treated shoots.

4. The method of vegetative propagation of Jatropha Curcas L. as defined in claim 3 wherein the shoot stimulator is selected from the group comprising 2,4-Dichlorophenoxyacetic acid, α-Napthalene acetic acid, 2-Methoxy-3,6-dichlorobenzoic acid, 4-Amino-3,5,6-trichloropicolinic acid and α-(p-Chlorophenoxy) isobutyl acid and wherein the root stimulator further comprises Benzylaminopurine, thiamine and chelated iron.

5. The method of vegetative propagation of Jatropha Curcas L. as defined in claim 4 wherein the shoots are sterilized after being harvested.

6. The method of vegetative propagation of Jatropha Curcas L. as defined in claim 5 wherein the root stimulator further comprises naphthalene Acetic Acid, indole butyric acid, benzyl amino purine and thiamine HCl.

7. The method of vegetative propagation of Jatropha Curcas L. as defined in claim 6 wherein the root stimulator further comprises Fe-EDTA.

8. The method of vegetative propagation of Jatropha Curcas L. as defined in claim 7 wherein the shoot stimulator comprises a solution of 2,4-Dichlorophenoxyacetic acid at a concentration of about 1,000 mgr/liter.

9. The method of vegetative propagation of Jatropha Curcas L. as defined in claim 8 wherein the shoot stimulator further comprises a plant fertilizer.

10. The method of vegetative propagation of Jatropha Curcas L. as defined in claim 3 wherein the root stimulator further comprises naphthalene Acetic Acid, indole butyric acid, benzyl amino purine, Fe-EDTA and thiamine HCl.

11. The method of vegetative propagation of Jatropha Curcas L. as defined in claim 3 wherein the shoot stimulator comprises a solution of 2,4-Dichlorophenoxyacetic acid at a concentration of about 1,000 mgr/liter and wherein the root stimulator comprises a solution of naphthalene Acetic Acid at a concentration of about 500 mgr/liter, indole butyric acid at a concentration of about 250 mgr/litre, benzyl amino purine, Fe-EDTA and thiamine HCl.

12. The method of vegetative propagation of Jatropha Curcas L. as defined in claim 1 wherein the shoot stimulator comprises a solution of 2,4-Dichlorophenoxyacetic acid at a concentration of about 1,000 mgr/liter and wherein the shoot stimulator comprises a solution of 2,4-Dichlorophenoxyacetic acid at a concentration of about 1,000 mgr/liter and wherein the root stimulator comprises a solution of naphthalene Acetic Acid at a concentration of about 500 mgr/liter, indole butyric acid at a concentration of about 250 mgr/litre, benzyl amino purine, Fe-EDTA and thiamine HCl.

13. The method of vegetative propagation of Jatropha Curcas L. as defined in claim wherein said root stimulator comprises an auxin in combination with Benzylaminopurine, thiamine HCl, and chelated iron.

14. The method of vegetative propagation of Jatropha Curcas L. as defined in claim wherein said root stimulator further comprises a mixture of Benzylaminopurine, thiamine HCl, chelated iron, and Mono Sodium Glutamate.

15. The method of vegetative propagation of Jatropha Curcas L. as defined in claim 3 wherein said root stimulator further comprises a mixture of Benzylaminopurine, thiamine HCl, chelated iron, and Mono Sodium Glutamate.

16. The method of vegetative propagation of Jatropha Curcas L. as defined in claim 1 wherein said root stimulator further comprises Mono Sodium Glutamate.

17. The method of vegetative propagation of Jatropha Curcas L. as defined in claim 1 wherein said root stimulator comprises a solution of Naphthalene Acetic Acid, Indole Butyric Acid, Benzyl Amino Purine, Mono Sodium Glutamate, Thiamine, and chelated iron.

18. The method of vegetative propagation of Jatropha Curcas L. as defined in claim 3 wherein said root stimulator comprises a solution of Naphthalene Acetic Acid, Indole Butyric Acid, Benzyl Amino Purine, Mono Sodium Glutamate, Thiamine, and chelated iron.

19. The method of vegetative propagation of Jatropha Curcas L. as defined in claim wherein said root stimulator comprises a solution of Naphthalene Acetic Acid, Indole Butyric Acid, Benzyl Amino Purine, Mono Sodium Glutamate, Thiamine, and chelated iron.
